(19) United States
(12) Patent Application Publication
(10) Pub. No.: US 2014/0258882 A1
(43) Pub. Date: Sep. 11, 2014

(54) COLLABORATIVE TASK MANAGEMENT

(71) Applicants: Markus Latzina, Wiesenbach (DE); Anoshirwan Soltani, Leimen (DE)

(72) Inventors: Markus Latzina, Wiesenbach (DE); Anoshirwan Soltani, Leimen (DE)

(21) Appl. No.: 13/793,362

(22) Filed: Mar. 11, 2013

(51) Int. Cl. G06F 3/0484

(52) U.S. Cl. CPC G06F 3/0484
USPC 715/751

(57) ABSTRACT

A computer-implemented method includes providing a collaborative task management tool coupled to a workflow management application. The method further includes generating, using the collaborative task management tool, user-selectable options for addressing an exception in an established workflow.

### BACKGROUND

A business process is a collection of related, structured activities or tasks that produce a specific service or product for a business. A business process may have management aspects (e.g., corporate governance and strategic management), operational aspects (e.g., purchasing, manufacturing, marketing, and sales) and support aspects (e.g., accounting, recruitment, and technical support). The analysis of business processes may include mapping of processes and sub-processes down to activity level. A business process model is a model of one or more business processes, and defines the ways in which operations are carried out to accomplish the intended objectives of an organization.

Business Process Modeling (BPM) in systems engineering represents processes of an enterprise, so that the current processes may be analyzed and improved. Business Process Modeling (BPM) may be implemented with information and computer technology. With advances in information and computer technology, fully executable BPM models are commercially available from large and small platform vendors.

Common approaches to business or workflow modeling rely on fixed connections between well-defined entities/operations. Typically, process steps in a course of action are performed in a rigid linear order in a pre-defined sequence. Alternative courses of actions are modeled by bifurcations within pre-defined sequences. Thus, the common approaches to business or workflow modeling provide alternative courses of actions in only a limited number of predicted or planned scenarios. Workflow systems designed for a limited number of predicted or planned scenarios can be frustrating and difficult to use in real situations and require a high level of user experience to deal with unplanned situations. Often reliance on such workflow systems that are designed for a limited number of predicted or planned scenarios prevents user completion of tasks which are necessary to accomplish the business purpose in dynamic situations. In some instances, costly workarounds bypassing the workflow systems become necessary to accomplish business purposes in the unpredicted or unplanned for scenarios.

Consideration is now being given to business process or workflow management systems, which are flexible and dynamic to respond to real situations in which unpredicted or unplanned business process events can occur.

### SUMMARY

In a general aspect, a computer system includes a processor, a memory, and a workflow management application, which includes a collaborative task management tool. The collaborative task management tool is configured to generate user-selectable options for addressing an exception in an established workflow.

In an aspect, the collaborative task management tool is configured to present the user-selectable options for addressing the exception in the established workflow on an interactive user interface, and an informational decision aid to guide a user's selection of one of the user-selectable options for addressing the exception in the established workflow.

In another aspect, for an instance where the exception in the established workflow is a new task inserted in the established workflow, the informational decision aid includes information to guide user selection of options to perform the new task.

In yet another aspect, for an instance where the exception in the established workflow is a need to assign a new task worker to perform a particular task in the established workflow, the informational decision aid includes a list of one or more candidates for the new task worker and their attributes for performing the particular task. For the same instance, the collaborative task management tool can be configured to present a handover proposal for preparing the new task worker to perform the particular task in the established workflow. The handover proposal can be in a form of a draft meeting notice for a handover meeting with the new task worker, and can include links to one or more of task information material and a name of a task trainer.

In a general aspect, a computer-implemented method involves executing instructions stored on a computer readable storage medium. The method includes providing a workflow management application, and providing a collaborative task management tool coupled to the workflow management application. The method may allow a user to collaboratively participate in addressing an exception to an established workflow. For this purpose, the method includes generating, using the collaborative task management tool, user-selectable options for addressing an exception in an established workflow.

In an aspect of the method, generating user-selectable options includes presenting an informational decision aid to guide the user's selection of one of the user-selectable options for addressing the exception in the established workflow. For an instance where the exception in the established workflow is a need to assign a new task worker to perform a particular task in the established workflow, the informational decision aid includes a list of one or more candidates and their attributes for performing the particular task. The candidate attributes included in the informational decision aid include their availability and skill level for performing the particular task. For the same instance, the method can further include presenting a handover proposal to the user for preparing the new task worker to perform the particular task. The handover proposal can be in a form of a draft meeting notice for a handover meeting with the new task worker and include links to one or more of task information material and a name of a task trainer.

In a still another aspect, for an instance where the exception in the established workflow is a new task inserted in the established workflow, the method includes presenting an informational decision aid to guide user selection of one of the user-selectable options to perform the new task.

In a general aspect, a non-transitory computer readable medium carries instructions capable of being executed on a processor, which instructions when executed allow a computer device to provide a workflow management application including a collaborative task management tool. The collaborative task management tool may be configured to generate user-selectable options for addressing an exception in an established workflow. Further, the instructions when executed may cause the collaborative task management tool to present an informational decision aid to guide the user's selection of one of the user-selectable options for addressing the exception in the established workflow. In an instance where the exception in the established workflow is a need to assign a new task worker to perform a particular task in the established workflow, the instructions when executed on the processor may cause the collaborative task management tool to present a handover proposal to the user for preparing the new task worker to perform the particular task in the established workflow.

The details of one or more implementations are set forth in the accompanying drawings and the description below. Further features of the disclosed subject matter, its nature and various advantages will be more apparent from the accompanying drawings the following detailed description, and the claims.

### BRIEF DESCRIPTION OF THE DRAWINGS

FIG. 1 is a schematic diagram of an example business process or workflow model for an airline travel ticketing process.

FIG. 2 is a block diagram illustration of an example collaborative task management system in which a workflow management application is configured with a collaborative management tool that allows a user to collaboratively participate in supervising or managing workflows, in accordance with the principles of the disclosure herein.

FIG. 3 is a schematic illustration of a scenario in which a task in a business process or workflow is reassigned to a different task worker.

FIG. 4 is a schematic illustration of a decision aid generated by the collaborative task management tool of FIG. 2 in the scenario of FIG. 3, in accordance with the principles of the disclosure herein.

FIG. 5 is a schematic illustration of a handover proposal generated by the collaborative task management tool of FIG. 2 in the scenario of FIG. 3, in accordance with the principles of the disclosure herein.

FIG. 6 is a schematic illustration of a scenario in which a new task is inserted in an established workflow.

FIG. 7 is a schematic illustration of a decision aid generated by the collaborative task management tool of FIG. 2 in the scenario of FIG. 6, in accordance with the principles of the disclosure herein.

FIG. 8 is a schematic illustration of an example use of the decision aid of FIG. 7 by a user to select an option for performing the new task, in accordance with the principles of the disclosure herein.

FIG. 9 is a flow chart illustration of an example computer-implemented method for semi-automated management of workflows in which a user can collaboratively participate in addressing an exception to an established workflow, in accordance with principles of the disclosure herein.

### DETAILED DESCRIPTION

In the context of a business process, a workflow is a depiction of a sequence of operations or tasks, which may be declared as work of a person, of a simple or complex mechanism, of a group of persons, of an organization, of staff, or of machines. Workflow may be seen as any abstraction of real work, segregated into workshare, work split or other types of ordering. While tasks may be described as being performed by human task workers herein, it will be understood that more generally the tasks may be performed by either human or inanimate entities (e.g., machines, computers, software modules etc.).

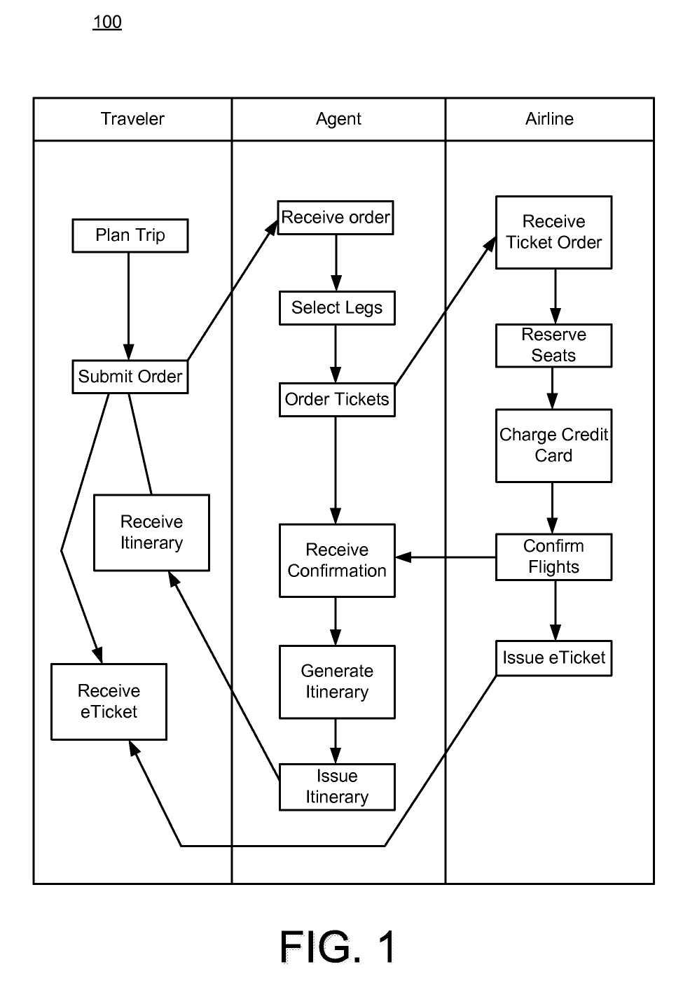

FIG.1, which is adapted from the web, shows an example business process or workflow model 100 for an airline travel ticketing process. Each rectangle in FIG. 1 represents a process step or task that must be done by a task worker. In workflow model 100, process steps in a course of action are performed in a rigid linear order in a pre-defined sequence. Alternative courses of actions are modeled by bifurcations within pre-defined sequences. Workflow model 100 may be implemented or executed automatically, for example, by a computerized airline reservation system.

In general, a conventional workflow management system is a computer system that manages and defines a series of tasks within a workflow. A workflow management system may allow the user to define different workflows for different types of jobs or processes. For example, in a manufacturing environment, a design document might be automatically routed from a designer to a technical director to the production engineer. At each stage in the workflow, one individual or group is responsible for a specific task. Once the task is complete, the workflow software ensures that the individuals responsible for the next task are notified and receive the data they need to execute their stage of the process.

In accordance with the principles of the disclosure herein, a Collaborative Task Management System (“CTMS”) includes features that allow collaborative management of tasks in a business process or workflow by a user and an underlying automated workflow management system. The underlying automated workflow management system may be sufficient to deal with a limited number of predicted or planned business process scenarios. The CTMS disclosed herein may be configured to guide manual selection by the user of alternative courses of action for completion of tasks and thus may be semi-automatic. The user may choose the alternative courses of action for completion of tasks, for example, to respond to unpredicted or unplanned business process events. In some implementations of the CTMS, the user may also choose alternative courses of action modifying or overriding the automated responses of the underlying automated workflow management system for completion of tasks in the limited number of predicted or planned business process scenarios for which the latter is designed. The features in the CTMS that allow the collaborative management of tasks may be fully integrated with or implemented as an add-on (e.g., as a plug-in software) to the underlying automated workflow management system.

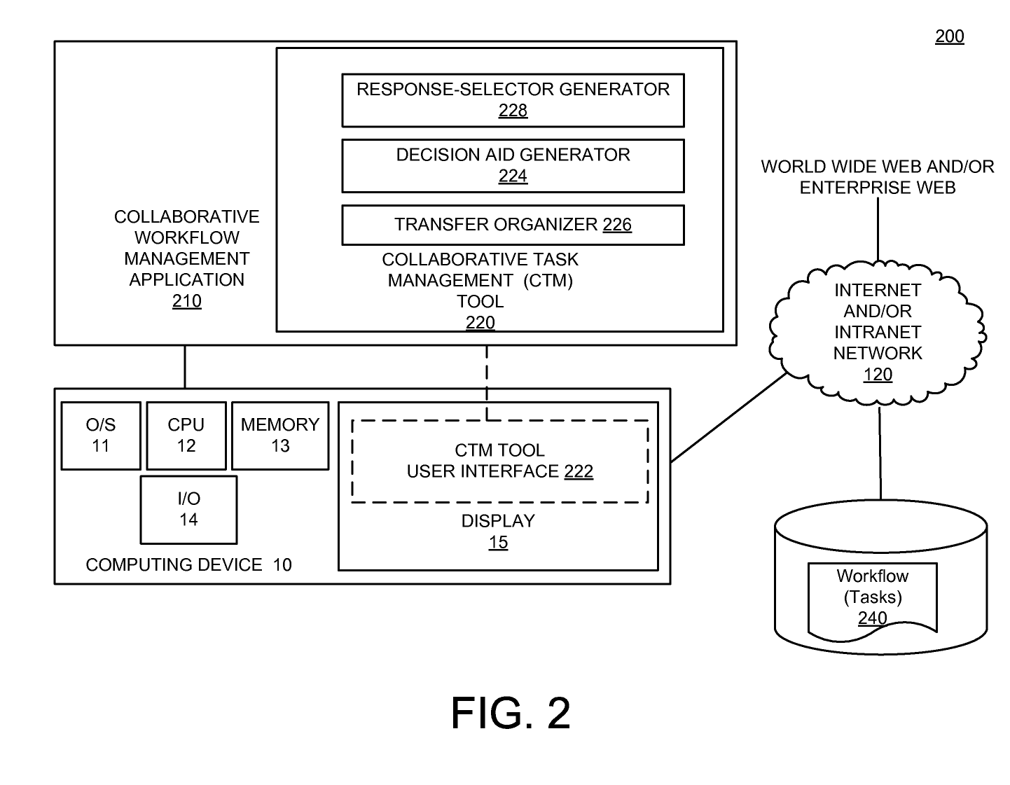

FIG. 2 shows an example Collaborative Task Management System (CTMS) 200 in which an automated workflow management application (e.g., collaborative workflow management application 210) is configured with a collaborative task management (CTM) tool 220 that allows a user to collaboratively participate in supervising or managing workflows, in accordance with the principles of the disclosure herein. For convenience in the description herein, the Collaborative Task Management System 200 may be alternatively referred to as either CTMS 200 or system 200.

In system 200, collaborative workflow management application 210 and collaborative task management tool 220 may be hosted on one or more standalone or networked physical or virtual computing machines. FIG. 2 shows, for example, workflow management application 210 hosted on a computing device 10 (e.g., a desktop computer, mainframe computer, personal computer, mobile computing device, laptop, tablet, or smart phone), which may be available to a user. Computing device 10, which includes an O/S 11, a CPU 12, a memory 13, I/O 14, may further include or be coupled to a display 15.

Workflow management application 210 along with CTM tool 220 may be configured to manage a particular business process or workflow (e.g., workflow 240) of an organization. Workflow management application 210 with CTM tool 220 may be linked, for example, via Internet or intranet connections (e.g., network 120), to data sources on the web (e.g., worldwide and/or enterprise webs) and/or or other computer systems of the organization (e.g., e-mail systems, human resources systems, material systems, operations, etc.) (not shown) that may have information relevant to the implementation of workflow 240.

In system 200, CTM tool 220 may include or be coupled to an interactive user interface (e.g., UI 222), which may be presented to a user, for example, on display 15. The system may have an intuitive visual interaction mode of operation so that it can be utilized by end users with little or no learning. For this purpose, UI 222 may be designed, for example, as an intuitive user interface that is amenable to touch or gesture interaction and allows modeling by “drag & drop” interaction.

System 200 may be configured to collaboratively redefine, and assign or reassign tasks in workflow 240 to different task workers toward meeting the business process purpose of workflow 240. The system may support new or alternate courses of action or process steps in response to workflow exceptions or unanticipated or unplanned for events. System 200 may utilize semantic inferences to dynamically determine which tasks need to be performed for the business process purpose. For example, the system may be configured to infer from the co-occurrence of two tasks or events of particular generic types in workflow 240 that a meta task pattern should be invoked. While the meta task pattern may have an overarching set of pre-defined parameters or constraints, the shape of the pattern may be dynamically changed in response to actual use by task workers.

CTM tool 220 may include modules (e.g., decision aid generator 224 and transfer organizer 226) that are configured to collect, organize and present information to the guide the user to collaboratively participate in managing tasks in workflow 240. CTM tool 220 may also include a module (e.g., response-selector generator 228) that is configured to present an interactive response configurator or selector by which a user can choose a response (e.g., a new or alternate course of action or process steps) to a workflow exception or special circumstance. The interactive response configurator or selector may be displayed, for example, on UI 222, together with information presented by decision aid generator 224 and/or transfer organizer 226. The interactive response configurator or selector may allow the user to configure the chosen response to the workflow exception or special circumstance by allowing the user to select, indicate or input attribute or parameter values that the user deems appropriate for the new or alternate course of action or process steps.

In the following description, the principles of the operation of CTMS 200 are explored in two scenarios (i.e. Scenario 1 and Scenario 2), both of which involve an exception or change in an established workflow. In Scenario 1, the exception or change in the established workflow involves reassignment of a task to a different task worker. In Scenario 2, the exception or change in the established workflow involves dynamic redefinition of tasks in response to changing business circumstances or events. In each scenario, CTMS 200 processes different information objects with correspondingly different relationships, attributes and values for before and after the exception or change.

### Scenario 1

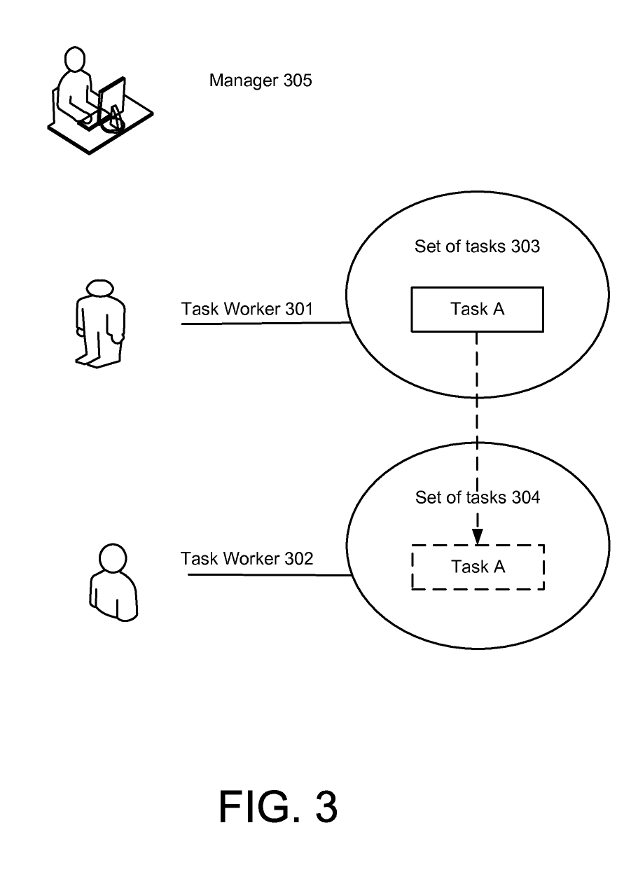

Scenario 1, as shown schematically in FIG. 3, relates to an instance where tasks in a business process or workflow may be reassigned to different task workers.

In Scenario 1, two task workers 301 and 302 may, for example, be assigned responsibility for Task Sets 303 and 304, respectively. Task Sets 303 and 304 may be part of a workflow for a business process under the supervision of a manager 305. Task Set 103 assigned to task worker 301 may, for example, include a specific task—Task A. If task worker 301 is on vacation and unavailable to accomplish Task A, a conventional workflow management system may automatically reassign Task A from task worker 301 to task worker 302 as shown in FIG. 3. Such reassignment may be accomplished, without involvement of manager 305, by the conventional workflow management system based, for example, on hard coding of task worker rosters and task worker availability or vacation schedules.

In contrast to manager 305's non-involvement in the task reassignment process in the conventional workflow management system, CTMS 200/CTM 210 may be deployed to allow manager 305 to collaboratively participate in the task reassignment process. CTM 210 may, for example, alert manager 305 to a changing situation related to performance of Task A. The alert may, for example, be triggered by a planned leave of responsible Task Worker 301, which may require that manager 305 find a substitute task worker to perform Task A while task worker 301 is on leave. As another example, the alert may be triggered by a customer's complaint about the handling of Task A by task worker 301. Response to the complaint may require that one or more task workers with more suitable sets of task skills replace task worker 301 to perform Task A. The alert may be routed to the manager through workflow management application 210/CTM tool 220 or by other means (e.g., a direct e-mail from task worker 301 requesting leave). In either case, manager 305 may use CTM 210 to collaboratively participate in reassignment of Task A.

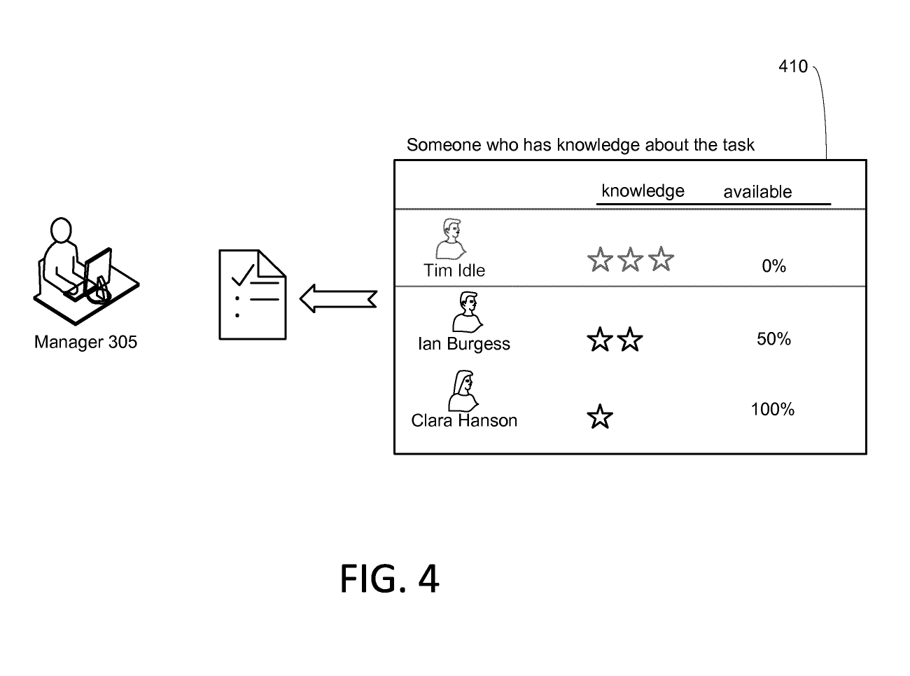

As noted before, CTM 210 may include decision aid generator 224, which may be configured provide information and guidance to manager 305 for changing the workflow tasks assignments in Scenario 1. In particular with reference to Task A, decision aid generator 224 may process information in organization databases and identify candidate task workers to whom Task A may be reassigned by manager 305. Decision aid generator 224 may present the candidate task workers and their attributes in a decision aid list (e.g., decision aid 410, FIG. 4) on user interface 222/display 15 to enable the manager to visually weigh different criteria for selecting a substitute or replacement task worker for Task A. Decision aid 410, as shown for example in FIG. 4, may include a shortlist of candidate task workers names (e.g., Tim Idle, Ian Burgess and Clara Hanson) and attributes such as skill or knowledge level and availability for Task A.

Manager 305 may, for example, choose a particular task worker to replace task worker 301 for Task A based on the particular task worker's skill or knowledge level in combination with availability that are listed in decision aid 410. The manager may, for example, choose task worker Clara Hanson from decision aid 410 even though she has poorer knowledge about Task A than the other candidates because she is available 100% of the time. Alternatively, the manager may choose task worker Ian Burgess from decision aid 410 even though he is available for only 50% of the time because he has a higher level of knowledge (50%) about Task A than the other available candidate—Clara Hanson. Thus, by providing a list of candidate task workers in decision aid 410, CTM 210 may enable manager 305 to collaboratively participate in the reassignment of Task A.

Decision aid 410 may be displayed on UI 222 as interactive response selector or configurator component by response-selector generator 228. The display of decision aid 410 as a configurator component may be arranged so that the manager can select or indicate his or her choice of a particular candidate task worker to replace task worker 301, for example, by clicking on candidate icon or name listed in decision aid 410 with a mouse cursor or pointer. The display of decision aid 410 as a response configurator component may include further user controls and input fields (e.g., an override button or other attribute input fields) (not shown) for the manager's use. The manager may, for example, use the other attribute input fields to enter a name of task worker who is not on the list of candidate task workers in decision aid 410 as his or her selection to replace task worker 301

CTM 210's provisioning of a decision aid list of candidate task workers with specific reference to Task A may be contrasted with conventional workflow management systems that may provide automated candidate lists, for example, by simple search of company rosters or personnel lists, without particular reference to Task A or task worker attributes relevant to Task A.

With renewed reference to FIG. 2, transfer organizer 226 in CTM tool 220 may be configured to generate further aids to help manager 305 facilitate the reassignment of Task A to the selected substitute or replacement task worker (e.g., task worker 302). Transfer organizer 226 may include algorithms that can assess attributes (e.g., availability and knowledge or proficiency) of the selected substitute or replacement task workers (e.g., task worker 302) for Task A, and generate further information to facilitate transfer of responsibility for Task A to the selected substitute or replacement task worker. The information generated for this purpose may include materials (e.g., background materials) to prepare or train the selected substitute or replacement task worker for Task A. A version of transfer organizer 226, may include algorithms that can assess attributes (e.g., availability and knowledge or proficiency) of the selected substitute or replacement task worker for Task A and the requirements for performing Task A to provide a conclusion that a certain amount of training or retraining may advisable. For such an instance, transfer organizer 226 may include algorithms that can generate and recommend a suitable training program for one or more candidate task workers for Task A. Transfer organizer 226 may determine if a personal trainer or guide is advisable, and recommend an appropriately qualified trainer. The trainer may, for example, be the current task worker (e.g., task worker 301), manager 305 or any other person with suitable knowledge about Task A.

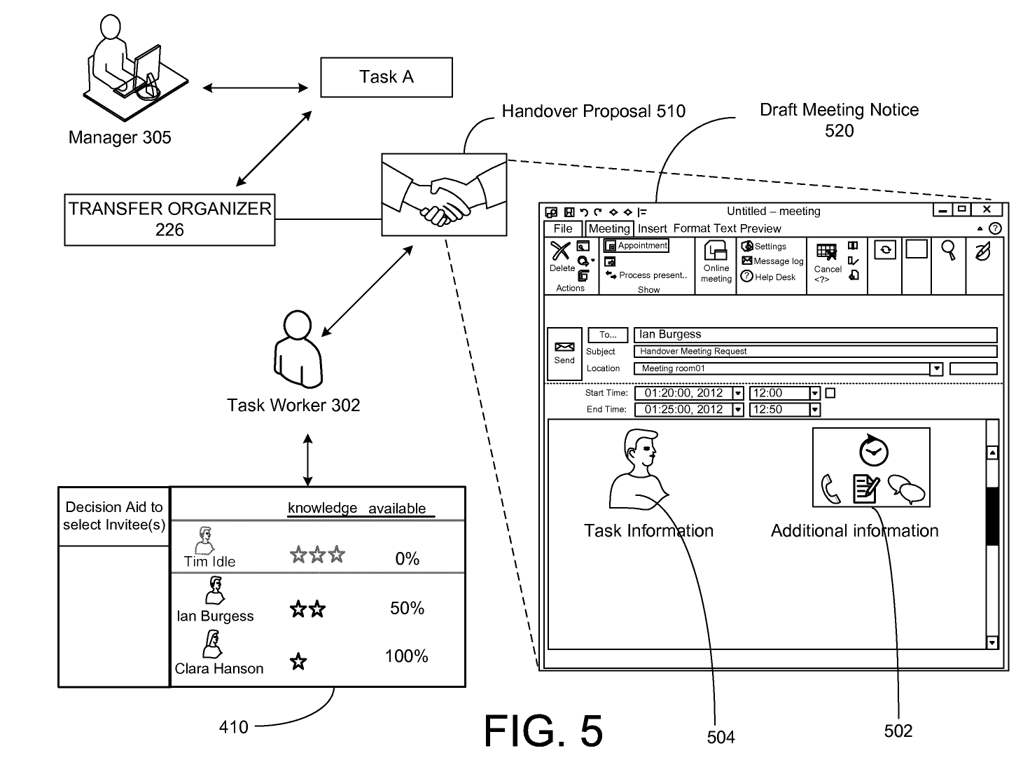

FIG. 5 shows an example of the further information and aids generated by CTM tool 220 to help manager 305 facilitate the reassignment of Task A to the selected substitute or replacement task worker. In particular, FIG. 5 shows a handover proposal 510 generated by the collaborative task management tool of FIG. 2 in Scenario 1, in accordance with the principles of the disclosure herein.

Transfer organizer 226 may generate a handover meeting proposal (e.g., handover proposal 510) to facilitate the transfer of responsibilities of Task A. Like decision aid 410 in FIG. 4, handover proposal 510 may be displayed on UI 222 as interactive response selector or configurator component by response-selector generator 228. The display of handover proposal 510 as a configurator component may be arranged so that the manager can select or indicate his or her choices of attribute or parameter values for the handover meeting to facilitate the transfer of responsibilities of Task A.

In one version of CTM tool 220, transfer organizer 226 may be configured to generate handover proposal 510 that includes or is linked to one or more aids (e.g., a draft e-mail meeting notice 520, decision aid 410 that can be used to select invitees, etc.) for consideration by the manager. As shown in the figure, draft e-mail meeting notice 520, which may be displayed on UI 222 for consideration by the manager, may be partially or fully pre-populated with information (e.g., meeting times and location, invitees, task informant or task trainer name 504, background materials 502, etc.) that may be relevant or useful for the proposed handover meeting. Draft e-mail meeting notice 520 may be configured so that the manager can override pre-populated entries and add or change entries before sending the e-mail meeting notice to the invitees. The manager may, for example, before inviting a particular individual to the handover meeting, use decision aid 410 to determine which candidates task workers to invite. The manager may, for example, invite more than one candidate to prepare several candidates to perform Task A and then possibly later assign shared responsibility for Task A to more than one trained candidate.

It will be understood that CTM tool 220 processes for managing a workflow (e.g., creating a handover proposal) may be based on a set of pre-defined logical rules. In an example set of logical rules, each task in the workflow may be associated with one or more variables and events, each of which may have associated properties. For example, a variable associated with a “Task” (e.g., Task A) may be “Actors” (e.g., manager, supervisor, task worker, trainer, etc.). The manager may be person or entity having responsibility for assigning tasks to other actors (e.g., task workers, trainers, etc.). “Task Information” may be a task property. “Assigning a Task” may be event. A property of an Assigning a Task event may be “Informing” (i.e. providing information) about the task. Informing may be a type of event (e.g., a “Task Informing Event”). Properties of a Task Informing Event may include “Task Informant”, “Task Informee”, “Task Information”, etc.

Example logic used by CTM tool 220 for creating a handover proposal (e.g., handover proposal 510) may, for example, be based on the following inferences: If a Task Worker is newly assigned to a Task, then the Task Worker needs information (Information Requirements) about the task (i.e., is a Task Informee); If the Manager needs to inform about a Task, the manager needs to hold a Task Informing Event; If a Task Worker was previously assigned to a Task, then this Task Worker is a Task Informer or Informant; If a Task Informing Event is to be held, the required Actors are (1) Manager, (2) Task Informant, and (3) Task Informee.

For generating a Task Informing Event (e.g., a Handover Meeting), the CTM tool 220 may include search heuristics for identifying a suitable Task Informant who is knowledgeable about the Task under concern. A possibly obvious candidate for a Task Informant may be the immediately previous Task assignee. However, the immediately previous Task assignee may not be available (e.g., due to sickness, sudden contract termination, or, for other reasons). In such an instance, the search heuristics may, for example, use known task properties to retrieve other previous Task assignees who are or were working on a similar task as the Task under concern. Alternatively or additionally, the search heuristics may exploit associations or links of Task assignees with related information resources to retrieve the particular resources which a previous Task assignee (e.g., task worker 101) was using for performing the Task. Alternatively or additionally, the search heuristics may exploit associations or links of Task assignees with various other stakeholders (e.g., recipients or consumers of his/her task outcomes or deliverables) and use the stakeholders as a reference to identify pieces of task-relevant information (i.e. Information Requirements), delivery of which may be part of the Task Information Event (the Handover Meeting). CTM tool 220 may dynamically leverage multi-faceted associations between the variables in order to identify relevant task-centric information for the Handover Meeting.

After the manger reassigns the task (as described with reference to FIG. 5 above) the CTMS application may prompt the Manager to hold a Handover Meeting. CTM tool 220 may be linked to a scheduling system and may propose a convenient date and time for scheduling the Handover Meeting. In the example of Scenario 1, in which Task A is reassigned to task worker 302, CTM tool 220 may generate a placeholder on UI 222 (e.g., in the manager's calendar) for a meeting invitation with the subject listed, for example, as “Discuss handover of Task A.” The placeholder may further, for example, list the meeting participants as Task Worker 1 and 2. It will be understood that the structure of the handover meeting may be modified based upon the circumstances and availability of the personnel. For example, if task worker 301 and task worker 302 are not available concurrently, the handover meeting may be conducted as a series of handover meetings in which a third person acts as an intermediary to convey task-relevant training information from task worker 301 to task worker 302. A first handover meeting may be between task worker 301 and the intermediary (e.g., the manager) followed by a second handover meeting between the intermediary and task worker 302.

The handover meetings may, for example, involve discussion of preconditions or expected deliverables with the affected task workers. CTM tool 220 may be configured to allow entry of meeting minutes to document, for example, manager and task worker understandings or agreements.

### Scenario 2

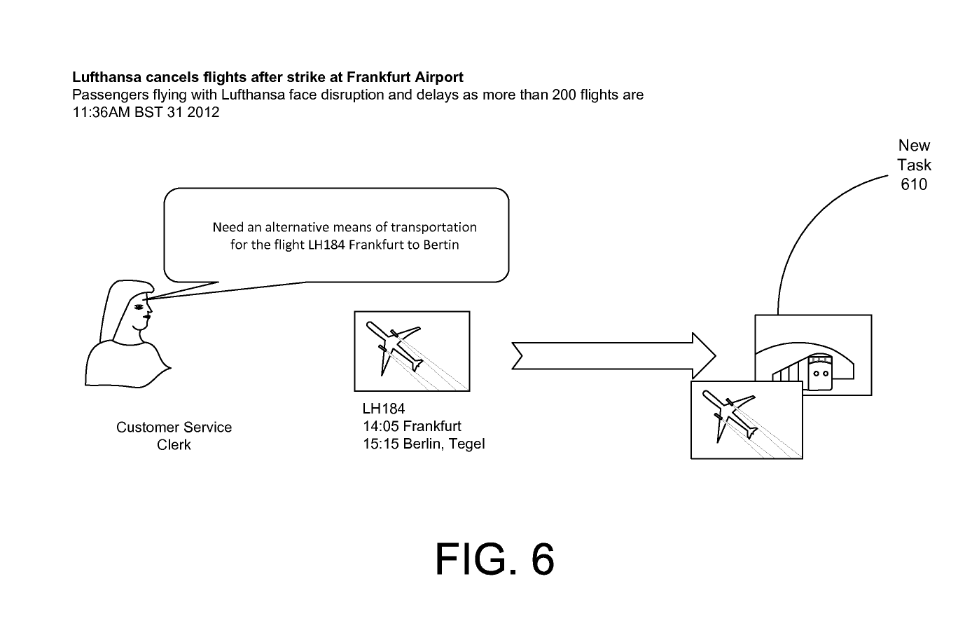

Scenario 2 may relate to an instance in which a business process or workflow is modified in response to a business event. In particular, as shown in FIG. 6, Scenario 2 may relate to a transportation rescheduling situation in which cancellation of all flights of commercial airline from Frankfurt to Berlin due to a labor strike presents a new task—making alternative travel arrangements for passengers booked on a cancelled flight (e.g., flight LH418).

In this scenario, CTMS 200 may be deployed in the commercial airline's passenger service systems to manage airline passenger booking workflows. CTM tool 220, which may be linked to the commercial airline passenger service systems, may also be linked to alternate transportation resources and passenger service systems. In response to the flight cancellations, the airline passenger booking workflows may be modified to include a new task 610 of finding alternate transportation (e.g., buses, taxis, trains, or other flights) for all of the passengers booked on the cancelled flights.

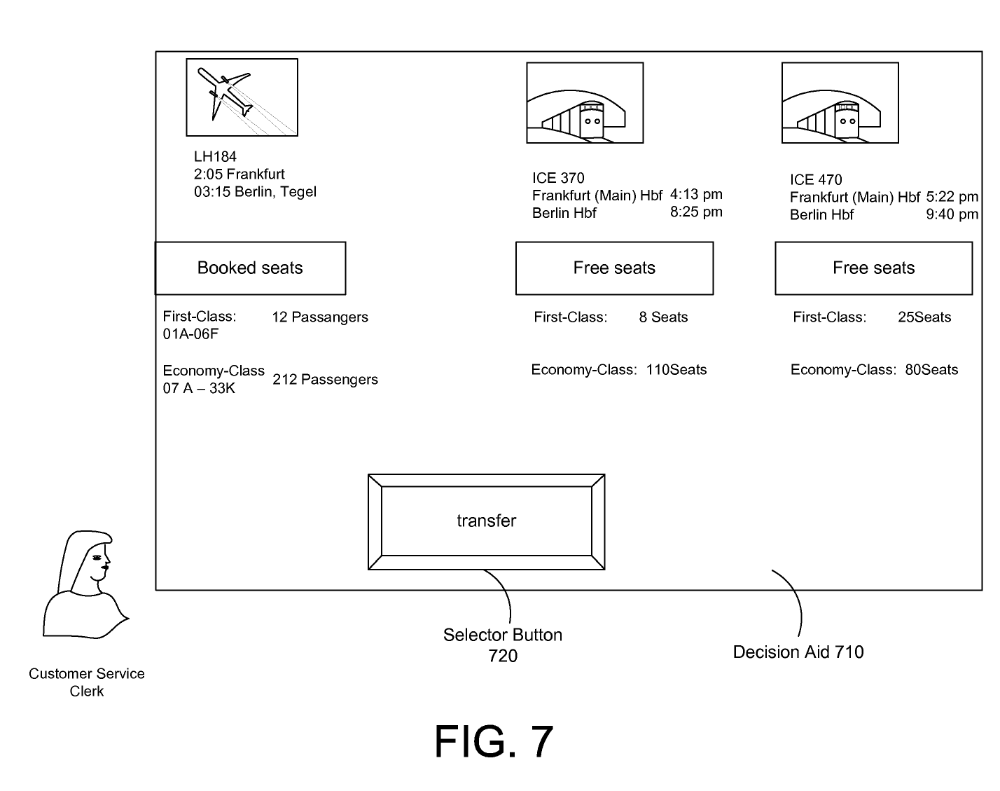

A customer service clerk may use CTM tool 220 in CTMS 200 to interactively find and collaboratively participate in making the alternative transportation arrangements for all of the passengers booked on the cancelled flight LH418. CTM tool 220 may be configured to dynamically access the other transportation resources and passenger service systems and generate options for the customer service clerk to select as the alternative transportation arrangements for the passengers booked on the cancelled flight. As shown in FIG. 7, CTM tool 220 may display information about suitable options for the alternative transportation arrangements to the customer clerk, for example, in an interactive decision aid 710 on UI 222. In the example decision aid 710 shown in the figure, information about the availability of seats on two train services (Train Nos. ICE 370 and ICE 470) running from Frankfurt to Berlin may be displayed for consideration by the customer service clerk. Interactive decision aid 710 may also include an activator (e.g., transfer button 720) by which the customer service clerk may manually select one or more of the displayed options.

In the example shown cancelled flight LH418 may have 12 passengers booked in first class and 200 passengers in economy class. CTM tool 220 may generate and display information about two alternative train services (Train Nos. ICE 370 and ICE 470) that may be matched or relevant to characteristics or properties of the original passenger bookings on the cancelled flight. For example, the displayed information may include the available number of seats by class and other features (e.g., food type and services) in each train. Passenger service levels may be considered according to the initial flight bookings reflecting, for example, respective class and particular passenger requirements (e.g., special diet, wheel chair assistance, family grouping, etc.).

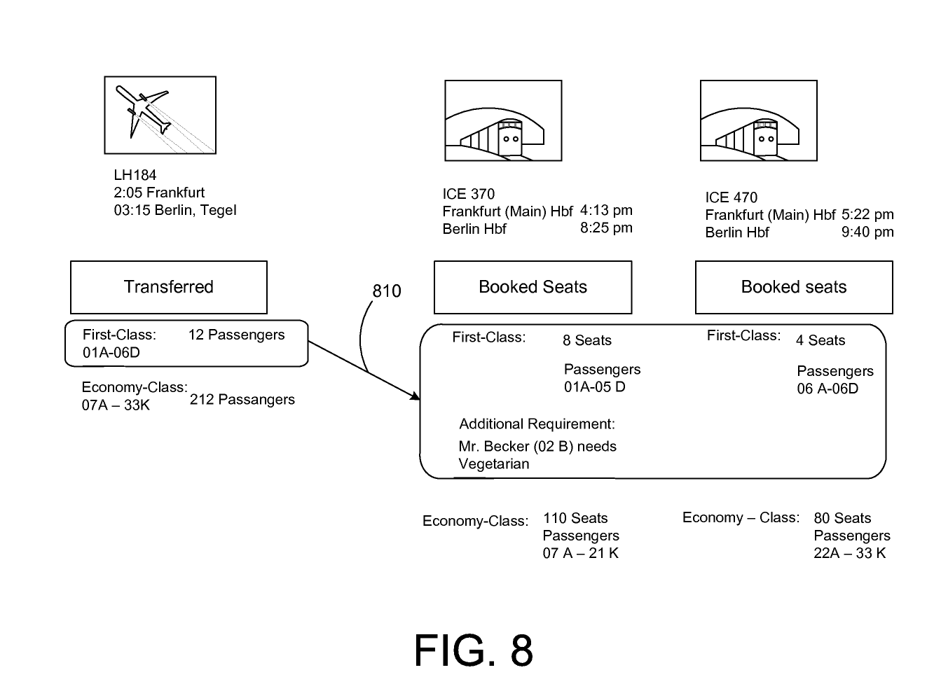

The displayed information may allow the customer service clerk to use an activator (e.g., transfer button 720) in decision aid 710 to transfer the flight bookings to the train bookings passenger-by-passenger or group-by-group while providing as much consistency as possible in passenger service levels as the original flight bookings FIG. 8 shows an example of the use of the activator in decision aid 710 by the customer service clerk to select options. As shown in FIG. 8, the customer service clerk may transfer (810) the flight bookings of 8 first class passengers from flight LH418 to Train No. ICE 370 and the remaining 4 first class passengers on Train No. ICE 470, respectively, according to the available number of seats on the two trains. Further, a meal type requirement (e.g., vegetarian meals) for a first class passenger (e.g., Mr. Becker) may be arranged on Train No. ICE 370 by the customer service clerk.

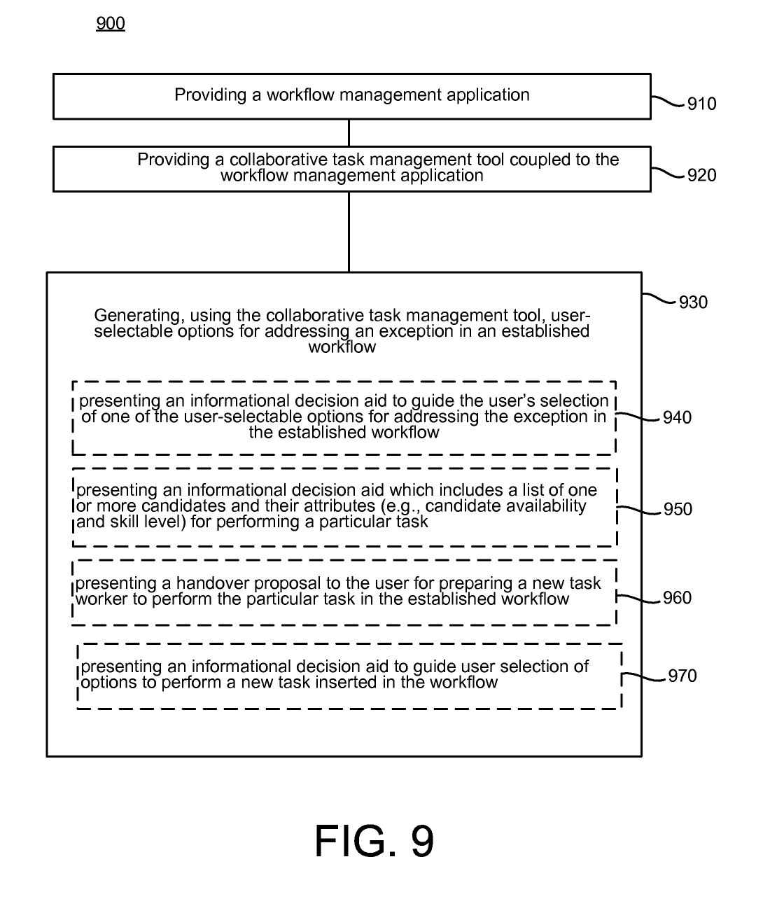

FIG. 9 shows an example computer-implemented method 900 for executing instructions stored on a computer readable storage medium. Method 900, which may be used for semi-automated management of workflows, includes providing a workflow management application (910), and providing a collaborative task management tool coupled to the workflow management application (920). Method 900 may allow a user to collaboratively participate in addressing an exception to an established workflow. For this purpose, method 900 may include generating, using the collaborative task management tool, user-selectable options for addressing an exception in an established workflow (930).

In method 900, generating user-selectable options for addressing an exception in an established workflow 930 may include presenting an informational decision aid to guide the user's selection of one of the user-selectable options for addressing the exception in the established workflow (940).

For an instance where the exception in the established workflow is a need to assign a new task worker to perform a particular task in the established workflow, presenting an informational decision aid 940 may include presenting an informational decision aid which includes a list of one or more candidates and their attributes for performing the particular task (950). The candidate attributes included in the informational decision aid may, for example, include their availability and skill level for performing the particular task. For the same instance, method 900 may include presenting a handover proposal to the user for preparing the new task worker to perform the particular task in the established workflow (960). The handover proposal may be in a form of a draft meeting notice for a handover meeting with the new task worker and may include links to one or more of task-relevant information materials and a name of a task trainer.

For an instance where the exception in the established workflow is a new task inserted in the established workflow, presenting an informational decision aid 940 may include presenting an informational decision aid to guide user selection of options to perform the new task inserted in the workflow (970).

A non-transitory computer readable medium may bear instructions capable of being executed on a processor, which instructions when executed may allow a computer device to provide a workflow management application including a collaborative task management tool. The collaborative task management tool may be configured to generate user-selectable options for addressing an exception in an established workflow. The instructions when executed may cause the collaborative task management tool to present an informational decision aid to guide the user's selection of one of the user-selectable options for addressing the exception in the established workflow. In an instance where the exception in the established workflow is a need to assign a new task worker to perform a particular task in the established workflow, the instructions when executed on the processor may cause the collaborative task management tool to present a handover proposal to the user for preparing the new task worker to perform the particular task in the established workflow

The various systems and techniques described herein may be implemented in digital electronic circuitry, or in computer hardware, firmware, software, or in combinations of them. The various techniques may implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a standalone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system, comprising:
a processor;
a memory; and
a workflow management application including a collaborative task management tool,
wherein the collaborative task management tool is configured to generate user-selectable options for addressing an exception in an established workflow.

2. The computer system of claim 1, wherein the collaborative task management tool is configured to present the user-selectable options for addressing the exception in the established workflow on an interactive user interface.

3. The computer system of claim 1, wherein the collaborative task management tool is configured to present an informational decision aid to guide a user's selection of one of the user-selectable options for addressing the exception in the established workflow.

4. The computer system of claim 3, wherein the exception in the established workflow is a new task inserted in the established workflow, and wherein the informational decision aid includes information to guide user selection of options to perform the new task.

5. The computer system of claim 3, wherein the exception in the established workflow is a need to assign a new task worker to perform a particular task in the established workflow, and wherein the informational decision aid includes a list of one or more candidates and their attributes for performing the particular task.

6. The computer system of claim 5, wherein the candidate attributes included in the informational decision aid include their availability and skill level for performing the particular task.

7. The computer system of claim 1, wherein the exception in the established workflow is a need to assign a new task worker to perform a particular task in the established workflow, and wherein the collaborative task management tool is configured to present a handover proposal to the user for preparing the new task worker to perform the particular task in the established workflow.

8. The computer system of claim 7, wherein the handover proposal is in a form of a draft meeting notice for a handover meeting with the new task worker.

9. The computer system of claim 7, wherein the handover proposal includes links to one or more of task-relevant information materials and a name of a task trainer.

10. A computer-implemented method for executing instructions stored on a computer readable storage medium, the method comprising:
providing a workflow management application; and
providing a collaborative task management tool coupled to the workflow management application,
generating, using the collaborative task management tool, user-selectable options for addressing an exception in an established workflow.

11. The method of claim 10 further comprising presenting an informational decision aid to guide the user's selection of one of the user-selectable options for addressing the exception in the established workflow.

12. The method of claim 11, wherein the exception in the established workflow is a need to assign a new task worker to perform a particular task in the established workflow, and wherein the informational decision aid includes a list of one or more candidates and their attributes for performing the particular task.

13. The method of claim 12, wherein the candidate attributes included in the informational decision aid include their availability and skill level for performing the particular task.

14. The method of claim 10, wherein the exception in the established workflow is a need to assign a new task worker to perform a particular task in the established workflow, and wherein the method further comprises presenting a handover proposal to the user for preparing the new task worker to perform the particular task in the established workflow.

15. The method of claim 14 further comprising presenting the handover proposal in a form of a draft meeting notice for a handover meeting with the new task worker.

16. The method of claim 14, wherein the handover proposal includes links to one or more of task information material and a name of a task trainer.

17. The method of claim 10, wherein the exception in the established workflow is a new task inserted in the established workflow, and wherein the method further comprises presenting an informational decision aid to guide user selection of options to perform the new task.

18. A non-transitory computer readable medium, comprising:
instructions capable of being executed on a processor, which instructions when executed allow a computer device to:
provide a workflow management application including a collaborative task management tool; and
generate, using the collaborative task management tool, user-selectable options for addressing an exception in an established workflow.

19. The non-transitory computer readable medium of claim 18, wherein the instructions when executed on the processor cause the collaborative task management tool to present an informational decision aid to guide the user's selection of one of the user-selectable options for addressing the exception in the established workflow.

20. The non-transitory computer readable medium of claim 18, wherein the exception in the established workflow is a need to assign a new task worker to perform a particular task in the established workflow, and wherein the instructions when executed on the processor cause the collaborative task management tool to present a handover proposal to the user for preparing the new task worker to perform the particular task in the established workflow
